(19) United States
(12) Patent Application Publication
(10) Pub. No.: US 2026/0115096 A1
(43) Pub. Date: Apr. 30, 2026

(54) SYSTEM AND METHOD FOR COLD PLUNGE

(71) Applicant: Joshua Philip Reed, Northlake, TX (US)

(72) Inventor: Joshua Philip Reed, Northlake, TX (US)

(73) Assignee: POLR, Northlake, TX (US)

(21) Appl. No.: 19/370,401

(22) Filed: Oct. 27, 2025

Related U.S. Application Data
(60) Provisional application No. 63/711,771, filed on Oct. 25, 2024.

(51) Int. Cl. A61H 33/00

(52) U.S. Cl. CPC A61H 33/0087; A61H 33/005; A61H 33/6005; A61H 2033/0083; A61H 2201/0214; A61H 2201/5058

(57) ABSTRACT

A system and method for enhanced cold-water immersion therapy using a cold plunge device. The system includes a cylindrical body with a double-walled construction having an outer wall and an inner wall defining a tapered inner chamber therebetween filled with insulation material. The tapered design accommodates convection principles with more insulation at the base. A water circulation system includes a pump, filtration unit, cooling unit, and at least one return jet strategically positioned to create a whirlpool effect that disrupts the thermal barrier layer that forms around a user's body during immersion, enhancing therapeutic effectiveness. A control system with sensors and processors monitors operational parameters and controls LED indicators that change color based on immersion duration. A locking lid with childproof capabilities and insulation 2-10 inches thick maintains water temperature efficiently, addressing the common problem of premature temperature rise in conventional portable cold plunge systems while providing enhanced safety features.

### CROSS REFERENCE TO RELATED APPLICATIONS

This application claims priority to U.S. Provisional Patent No. 63/711,771 filed on Oct. 25, 2024 which is incorporated in its entirety.

### BACKGROUND

Cold plunging is a type of cold-water immersion that has gained popularity for its potential health benefits. This practice involves immersing the body in cold water for short periods, usually ranging from a few seconds to several minutes. Cold plunging can help with reduced muscle soreness and inflammation, which may aid in post-exercise recovery. Cold plunging can improve circulation by causing blood vessels to constrict and dilate, potentially enhancing overall blood flow. Additionally, there ss growing interest in the cardiovascular benefits of cold plunging, with some research suggesting improvements in heart rate variability and overall cardiovascular function.

Cold plunge tubs come in various types to suit different needs, preferences, and settings. Portable ice baths offer flexibility and ease of use, with inflatable or collapsible designs. These are often filled with ice and water manually. For those seeking a more permanent solution, standalone cold plunge tubs can be installed indoors or outdoors, typically equipped with cooling and filtration systems for maintenance-free operation. A common problem with the portable ice baths is that they lack insulation, causing the temperature to rise prematurely. They also do not interrupt the thermal barrier which is the layer of warmer water that forms around your body when you enter cold water, causing the layer to insulate you from the full effects of the cold water. Another concern is that they do not provide for the necessary safety for children who may become stuck in the cold plunge and eventually drown. Thus exists a new system and method for a cold plunge.

### SUMMARY

The embodiments of the present invention are directed to a system and method, according to one or more exemplary embodiments, for a cold plunge system that provides a whirlpool effect used to disrupt thermal barriers, allowing for a more intense and effective cold plunge experience. The cold plunge system also has added insulation and a tapered design to accommodate for the principle of convection in fluids with warm water rising to the top along with a locking lid to secure water for later use.

In some aspects, the techniques described herein relate to a cold plunge system including: a body having a base, a sidewall extending upward from the base, and an opening at a top of the body, wherein the sidewall includes an outer wall and an inner wall defining an inner chamber therebetween; an insulation material disposed within the inner chamber; and a pump system configured to circulate water within the body.

In some aspects, the techniques described herein relate to a cold plunge system further including at least one return jet positioned in the sidewall and configured to create a whirlpool effect within the body to disrupt a thermal barrier formed around a user, wherein the at least one return jet is configured to direct water at an angle toward the sidewall to create the whirlpool effect.

In some aspects, the techniques described herein relate to a cold plunge system wherein the angle of the water the at least one return jet directs is approximately 90 degrees relative to a radius of the body.

In some aspects, the techniques described herein relate to a cold plunge system, wherein the inner chamber has a tapered shape with more insulation at a bottom surface than at the top.

In some aspects, the techniques described herein relate to a cold plunge system, wherein the insulation material included is of closed-cell polyurethane foam.

In some aspects, the techniques described herein relate to a cold plunge system, wherein the insulation material is included of expanded polyurethane foam.

In some aspects, the techniques described herein relate to a cold plunge system, wherein the insulation material has a thickness between 2 and 10 inches.

In some aspects, the techniques described herein relate to a cold plunge system, further including a lid configured to be secured to the body at the opening with a locking mechanism positioned between corresponding holes in the lid and body.

In some aspects, the techniques described herein relate to a cold plunge system, further including: a control system having one or more processors; one or more sensors in communication with the control system; and a power system configured to provide power to the control system.

In some aspects, the techniques described herein relate to a cold plunge system, further including a plurality of light sources connected to the control system, wherein the control system is configured to control the light sources based on signals received from the one or more sensors.

In some aspects, the techniques described herein relate to a cold plunge system, wherein the control system is configured to: cause the light sources to emit a first color when a user enters the cold plunge system.

In some aspects, the techniques described herein relate to a cold plunge system, wherein the control system is configured to: cause the light sources to emit a second color when a predetermined time period has elapsed.

In some aspects, the techniques described herein relate to a cold plunge system, wherein the pump system includes: an intake port for drawing water from the body; a filtration system for removing contaminants from the water; a cooling system for reducing temperature of the water; and the at least one return jet for returning cooled and filtered water to the body.

In some aspects, the techniques described herein relate to a cold plunge system, wherein the cooling system includes a chiller unit having a compressor and refrigerant.

In some aspects, the techniques described herein relate to a method for operating a cold plunge system, the method including: filling a body of the cold plunge system with water, the body having an inner wall and an outer wall with insulation therebetween; activating a pump system to circulate the water; directing the water through at least one return jet positioned at an angle to create a whirlpool effect within the body; disrupting a thermal barrier layer that forms around a user in the water via the whirlpool effect; and maintaining water temperature via a cooling system integrated with the pump system.

In some aspects, the techniques described herein relate to a method, further including: detecting entry of a user into the cold plunge system via one or more sensors; initiating a timer upon detecting the user entry; and changing a color of one or more light sources from a first color to a second color when a predetermined time period has elapsed.

In some aspects, the techniques described herein relate to a method for operating a cold plunge for reducing post-exercise inflammation including: creating a vortex flow; maintaining a water temperature wherein the vortex pattern reduces inflammation markers more than static cold immersion.

### BRIEF DESCRIPTION OF DRAWINGS

The present invention will be described by way of exemplary embodiments, but not limitations, illustrated in the accompanying drawings in which like references denote similar elements, and in which:

FIG. 1 shows a block diagram of the various systems of the cold plunge.

FIG. 2 shows an illustration of the cold plunge.

FIG. 3 shows another illustration of the cold plunge.

FIG. 4 shows another illustration of the cold plunge

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or another embodiment in the present disclosure can be, but not necessarily are, references to the same embodiment; and such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skills in the art to which this disclosure pertains.

In the case of conflict, the present document, including definitions, will control. It will be appreciated that terms such as “front,” “back,” “top,” “bottom,” “side,” “short,” “long,” “up,” “down,” and “below” used herein are merely for ease of description and refer to the orientation of the components as shown in the figures. It should be understood that any orientation of the components described herein is within the scope of the present invention.

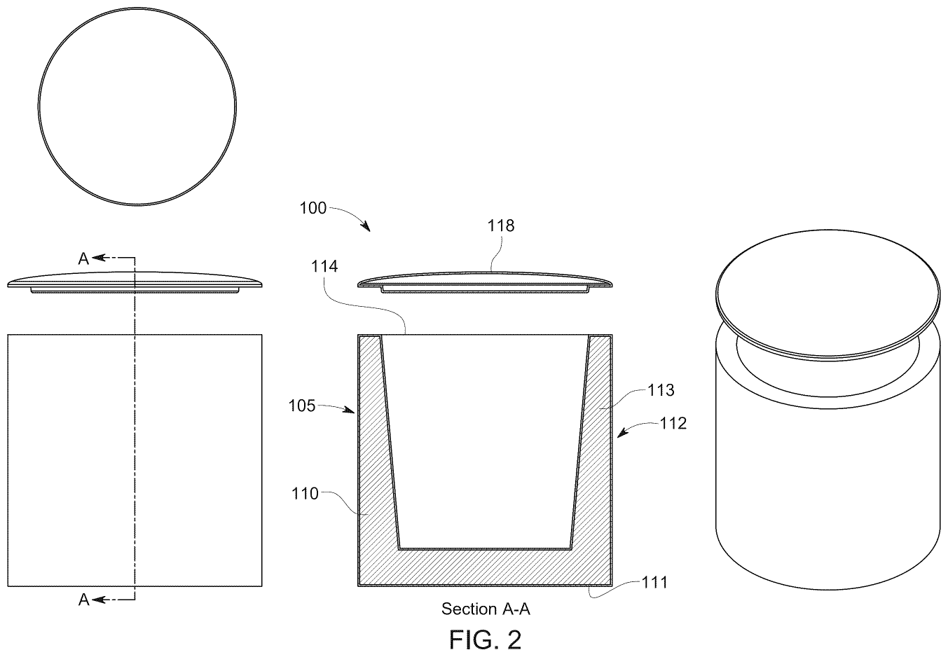

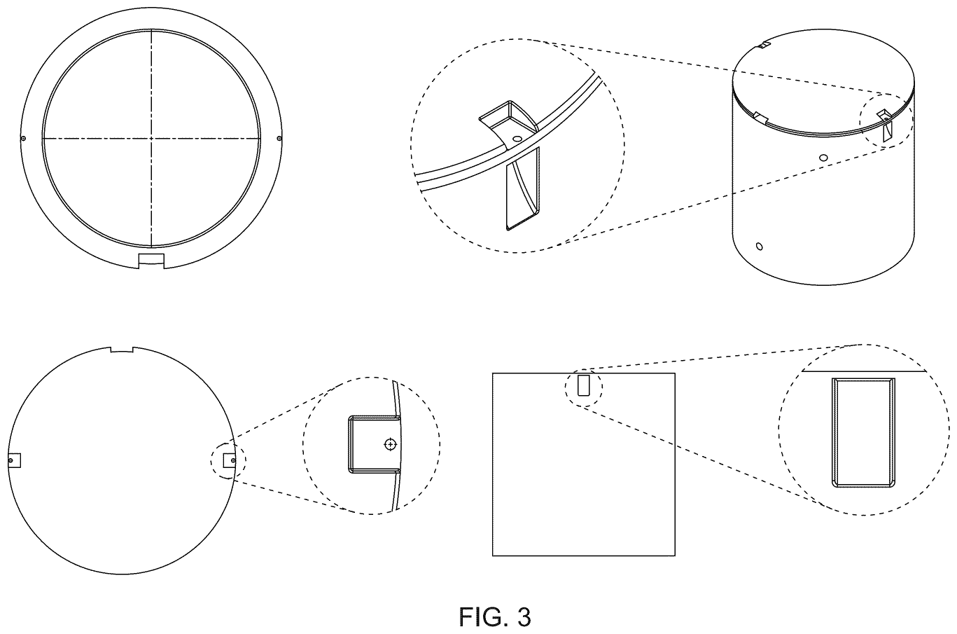

With reference now to FIG. 2, an exemplary embodiment of a cold plunge 100 is shown with a cylindrical shape body 105 having a base 110 that comes in contact with a ground or surface when cold plunge 100 is placed up on the ground or surface. In this embodiment, base 110 may have a bottom surface 111 extending upward into a circular sidewall 112. Circular sidewall 112 may have a cylindrical shape or any other suitable shape such as an oval. Cylindrical sidewall 112 may extend upward until forming an opening 114 at a top of the container. A lid 118 may be secured to body 105, as illustrated in FIG. 3, using a friction fit or any number of fasteners including rotating tabs locks positioned around a perimeter of lid 118 that are secured in on one or more indents of the lid 118. Lid 118 and body 105 may have one or more holes such that a lock or other device may be positioned between the two holes to lock lid 118 to body 105. Cold plunge 100 may be made of a high-density polyethylene (HDPE) or other sturdy plastics for cold plunge tubs. However, this is non-limiting and may be made of stainless steel, acrylic, fiberglass, or other materials

Circular sidewall 112, in one or more embodiments, has an outer wall, and an inner wall, creating an inner chamber 113. Inner chamber 113 may be configured to serve as a large container or vessel for insulation positioned between the outer wall and inner wall. In operation, the insulation may be poured into inner chamber 113 between the outer wall and inner wall. Inner chamber 113 may have a tapered shape, such that inner chamber 113 has more insulation at a bottom surface in order to better conform to the principles of thermodynamics. In a preferred embodiment insulation may be two to ten inches thick.

Insulation may be in the form of closed-cell polyurethane foam that may be sprayed or injected into body 105, creating a barrier against heat transfer. Insulation may also be in the form of expanded polyurethane foam, which can be cut to fit the interior chamber's 113 contours. Insulation may be in other forms depending on the circumstance and need.

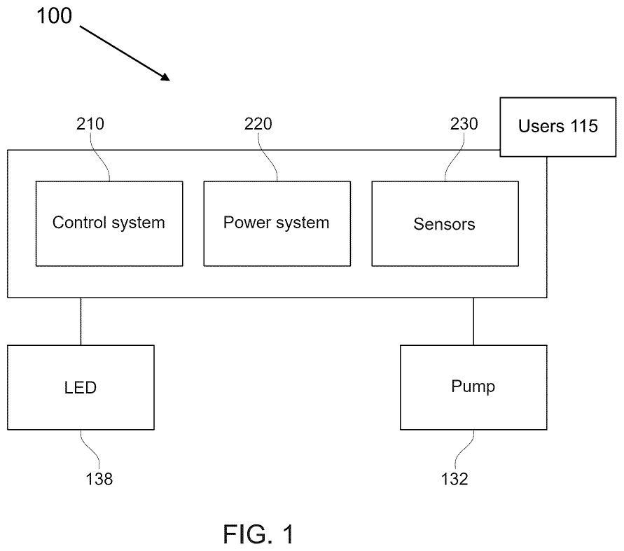

As illustrated in FIG. 1, cold plunge 100 may have one or more power systems 220 that provide power to various components and the circuits and components of a control system 210. Power system 220 may include a rechargeable battery pack whereby the rechargeable battery is of a charge, design, and capacity to provide sufficient power to power the components of cold plunge 100.

Control system 210 may operate to control the actuation of the other systems. Control system 210 may have a series of computing devices. The control system may be in the form of a circuit board, a memory or other non-transient storage medium in which computer-readable coded instructions are stored and one or more processors configured to execute the instructions stored in the memory. Control system 210 may have a wireless transmitter, a wireless receiver, and a related computer process executing on the processors.

Computing devices of control system 210, may be any type of computing device that typically operates under the control of one or more operating systems, which control scheduling of tasks and access to system resources. Computing devices may be a phone, tablet, television, desktop computer, laptop computer, gaming system, wearable device electronic glasses, networked router, networked switch, networked, bridge, or any computing device capable of executing instructions with sufficient processor power and memory capacity to perform operations of the control system.

The one or more computing devices may be integrated into control system 210, while in other non-limiting embodiments, control system 210 may be a remotely located computing device or server configured to communicate with one or more other control systems. The control system may also include an internet connection, network connection, and/or other wired or wireless means of communication (e.g., LAN, etc.) to interact with other components. The connection allows a user to update, control, send/retrieve information, monitor or otherwise interact passively or actively with control system 210.

Control system 210 may include control circuitry and one or more microprocessors or controllers acting as a servo control mechanism capable of receiving input from sensors 230 and other components analyzing the input from sensors and other components, and generating an output signal to components. The microprocessors (not shown) may have on-board memory to control the power that is applied to the various systems. The control system may include circuitry to provide an actuable interface for a user to interact with, including switches and indicators and accompanying circuitry for an electronic control panel or mechanical control panel. The control system may be preprogrammed with any reference values, by any combination of hardwiring, software, or firmware to implement various operational modes including, but not limited to, temperature, light, and humidity values.

The microprocessors in the control system 210 may also monitor the current state of circuitry within the control system 210 to determine the specific mode of operation chosen by the user. For instance, when “on”, the microprocessors may begin recirculating water at predetermined intervals as well as a timer system for keeping track of how long the user has been in cold plunge 100. Further, such microprocessors that may be part of the control system may receive signals from any of or all systems. Such systems may be notified whether any of the components in the various systems need to be replaced.

Cold plunge 100 may have one or more sensors 230 or detectors mounted or otherwise connected. Sensors 230 may include one or more suitable types of sensors, such as an optical sensor, an image capturing device such as a still camera or video camera, an audible sensor, a proximity sensor, a movement sensor, temperature sensor, or a weight sensor. Sensors 230 may have infrared (“IR”) detectors having photodiodes and related amplification and detection circuitry. Sensors 230 may have one or more digital scales capable of determining when Cold plunge 100 is in use.

Cold plunge 100 may have a plurality of light sources 138 (e.g., a light emitting diode (“LED”)) on the housing of body 105 and lid 118 such as along the perimeter of the sidewalls 112. Power system 220 provides power to the light source. Light sources 138 may be connected to control system 210 whereby control system 210 may receive signals from one or more sensors 230 or a timer system and sends a signal to Light sources 138. Light sources 138 may light up or flash colors when certain events occur, such as if users 115 have reached a desired amount of time in cold plunge 100. For example, when the user enters cold plunge 100, Light sources 138 may emit a red-light color, while once the user has reached their selected time or a designated time, Light sources 138 may emit a green light color to signal that the user has reached a desired amount of time and may leave. In other embodiments, a speaker assembly may produce an audible sound when events such as these occur to notify and alert the user.

Cold plunge 100 may include or otherwise be connected to one or more pump 132 whereby pump 132 are designed to perform multiple functions simultaneously, including water circulation, filtration, and cooling. During use, water may be drawn from body 105, processed, and then returned. Initially, the pump 132 pulls water through an intake port. This water then passes through a filtration system, removing debris and contaminants to maintain water clarity and hygiene. After filtration, the water is directed through a cooling system, such as a chiller unit, using a compressor and refrigerant to lower the water temperature. Once cooled and filtered, the water is pumped back into the tub through a return jet 129.

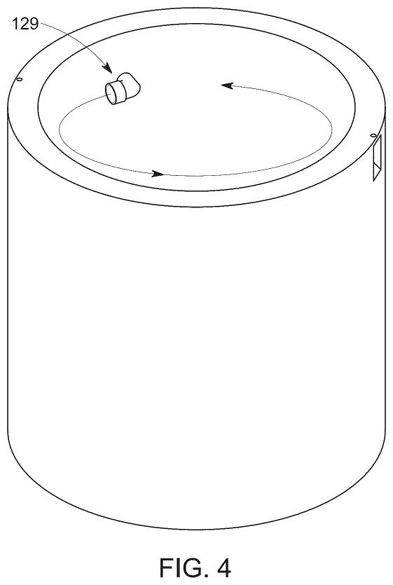

Return jet 129, as illustrated in FIG. 4, is designed to deliver a targeted stream of water at 90 degrees where it hits sidewalls 112 and starts to go in a circle, creating a whirlpool effect and enhancing circulation within body 105. Return jet 129 may include a jet body, faceplate, and nozzle. However, this angle is non-limiting and may be any suitable angle directed to a sidewall or edge of the body to create the whirlpool effect. The angle of 85-95 degrees creates a flow rate. The jet body may be housing that fits into sidewalls 112, providing a secure mounting point and a pathway for water flow. The nozzle behind the faceplate may direct the water flow, determining the jet's pressure and pattern. Return jet 129 may include impellers or propellers to further increase water pressure and flow rate.

Pump 132 may be connected to one or more valves at or near the bottom of a drainage hole for containing water in body 105. Valves may be spring-loaded, whereby when engaged or otherwise activated (e.g., such as by a motorized system receiving signals from the control system), the valve is opened thus permitting the flow of water to pump 132. Valves may have a stopper, whereby the spring biases the stopper against movement in one direction to create a normally closed position. In one embodiment, when the control system 210 sends a signal to the motor that is connected to the valves to open valves, a force is applied against the spring causing the spring to be depressed as well as the stopper to be activated and to move upward along with the spring. In another embodiment, the valve may be opened and closed by a manual actuator and stopper. In operation, the control system may send a signal to another mechanical system for the valve to open and to allow water to be released from body 105 to pump 132 and then flushed from body 105 to be recirculated.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A cold plunge system comprising:
a body having a base, a sidewall extending upward from the base, and an opening at a top of the body, wherein the sidewall comprises an outer wall and an inner wall defining an inner chamber therebetween;
an insulation material disposed within the inner chamber; and
a pump system configured to circulate water within the body.

2. The cold plunge system of claim 1 further comprising at least one return jet positioned in the sidewall and configured to create a whirlpool effect within the body to disrupt a thermal barrier formed around a user, wherein the at least one return jet is configured to direct the water at an angle toward the sidewall to create the whirlpool effect.

3. The cold plunge system of claim 2 wherein the angle is approximately 90 degrees relative to a radius of the body.

4. The cold plunge system of claim 1, wherein the inner chamber has a tapered shape with more insulation material at a bottom surface than at the top of the body.

5. The cold plunge system of claim 4, wherein the insulation material is comprised of closed-cell polyurethane foam.

6. The cold plunge system of claim 4, wherein the insulation material is comprised of expanded polyurethane foam.

7. The cold plunge system of claim 4, wherein the insulation material has a thickness between 2 and 10 inches.

8. The cold plunge system of claim 1, further comprising a lid configured to be secured to the body at the opening with a locking mechanism positioned between corresponding holes in the lid and the body.

9. The cold plunge system of claim 1, further comprising: a control system having one or more processors; one or more sensors in communication with the control system; and a power system configured to provide power to the control system.

10. The cold plunge system of claim 9, further comprising a plurality of light sources connected to the control system, wherein the control system is configured to control the plurality of light sources based on signals received from the one or more sensors.

11. The cold plunge system of claim 10, wherein the control system is configured to:
cause the plurality of light sources to emit a first color when a user enters the cold plunge system.

12. The cold plunge system of claim 11, wherein the control system is configured to:
cause the plurality of light sources to emit a second color when a predetermined time period has elapsed.

13. The cold plunge system of claim 10, wherein the pump system comprises: an intake port for drawing the water from the body; a filtration system for removing contaminants from the water; a cooling system for reducing temperature of the water.

14. The cold plunge system of claim 13, wherein the pump system comprises: at least one return jet for returning cooled and filtered water to the body.

15. The cold plunge system of claim 14, wherein the cooling system comprises a chiller unit having a compressor and refrigerant.

16. A method for operating a cold plunge system, the method comprising:
filling a body of the cold plunge system with water, the body having an inner wall and an outer wall with insulation therebetween;
activating a pump system to circulate the water;
directing the water through at least one return jet positioned at an angle to create a whirlpool effect within the body;
disrupting a thermal barrier layer that forms around a user in the water via the whirlpool effect; and
maintaining water temperature via a cooling system integrated with the pump system.

17. The method of claim 16, further comprising:
detecting entry of the user into the cold plunge system via one or more sensors;
initiating a timer upon detecting the user entry; and
changing a color of one or more light sources from a first color to a second color when a predetermined time period has elapsed.

18. A method for operating a cold plunge for reducing post-exercise inflammation comprising: creating a vortex flow pattern; and maintaining a water temperature.
